(19) United States
(12) Patent Application Publication
(10) Pub. No.: US 2021/0362255 A1
(43) Pub. Date: Nov. 25, 2021

(54) SAW TOOTH HOLDER, CUTTING DISK FOR A ROTARTY CUTTING MACHINE AND ROTARY CUTTING MACHINE INCLUDING SAME

(71) Applicant: Stephen MacLennan, St. Zacharie (CA)

(72) Inventor: Stephen MacLennan, St. Zacharie (CA)

(21) Appl. No.: 17/395,196

(22) Filed: Aug. 5, 2021

Related U.S. Application Data
(63) Continuation of application No. 16/408,129, filed on May 9, 2019, now abandoned.
(60) Provisional application No. 62/670,316, filed on May 11, 2018.

(51) Int. Cl. B23D 61/04; B27B 33/08; A01G 23/091

(52) U.S. Cl. CPC B23D 61/04; A01G 23/091; B27B 33/08

(57) ABSTRACT

The present disclosure concerns a saw tooth holder for a cutting disk of a rotary cutting machine. The saw tooth holder comprises a holder body having a tooth-receiving surface abuttable against a rear surface of a saw tooth of a tooth assembly and a trailing surface, opposed to the tooth-receiving surface, and defining a trailing oblique angle with respect to the tooth-receiving surface. The holder body has a fastener-receiving aperture extending therethrough between the tooth-receiving surface and the trailing surface and being accessible from the tooth-receiving surface and the trailing surface. The present disclosure also concerns a cutting disk comprising such a saw tooth holder, a saw tooth holder in combination with a tooth assembly, and a rotary cutting machine comprising such a cutting disk.

### CROSS-REFERENCE TO RELATED APPLICATIONS

This application is a continuation of U.S. patent application Ser. No. 16/408,129, filed May 9, 2021, which claims benefit to U.S. Provisional Application Ser. No. 62/670,316 filed on May 11, 2018, which are hereby incorporated herein by reference in their entirety.

### TECHNICAL FIELD

The technical field relates to rotary cutting machines and, more particularly, to a saw tooth holder to mount a tooth assembly to a cutting disk of a rotary cutting machine. It also relates to a cutting disk and a rotary cutting machine including a plurality of peripherally extending saw tooth holders.

### BACKGROUND

It is known to use rotary cutting machines, such as circular saws, for cutting workpiece materials such as wood, timber or trees. Such rotary cutting machines usually have saw teeth removably mounted to a plurality of peripherally interspaced positions on a cutting disk of the rotary cutting machine via corresponding saw tooth holders. Cutting relatively hard workpiece materials imparts high levels of stress on the saw teeth and on the saw tooth holders, which may weaken the saw tooth holders or even result in their breakage.

In view of the above, there is a need for a saw tooth holder which would be able to overcome or at least minimize some of the above-discussed prior art concerns so as to improve the durability of the rotary cutting machines.

### BRIEF SUMMARY

It is therefore an aim of the present invention to address the above-mentioned issues.

According to a general aspect, there is provided a saw tooth holder for a cutting disk of a rotary cutting machine. The saw tooth holder comprises a holder body extending between a tooth-receiving surface configured to contact a saw tooth of a tooth assembly and a trailing surface. The holder body has a fastener-receiving aperture extending therethrough and between the tooth-receiving surface and the trailing surface, wherein the trailing surface defines an oblique angle with respect to the tooth-receiving surface.

According to another general aspect, there is provided a saw tooth holder for a cutting disk of a rotary cutting machine. The saw tooth holder comprises a holder body extending between a tooth-receiving surface configured to contact a saw tooth of a tooth assembly and a trailing surface. The holder body has a fastener-receiving aperture extending therethrough, between the tooth-receiving surface and the trailing surface, and along a fastener axis, wherein the trailing surface defines an oblique angle with respect the fastener axis.

According to another general aspect, there is provided a saw tooth holder for a cutting disk of a rotary cutting machine. The saw tooth holder comprises a holder body extending between a tooth-receiving surface configured to contact a saw tooth of a tooth assembly and a trailing surface. The holder body has a fastener-receiving aperture extending therethrough and between the tooth-receiving surface and the trailing surface, and a fastener-receiving socket (or counterbore) defined in the holder body from the trailing surface and surrounding the fastener-receiving aperture, the fastener-receiving socket/counterbore being delimited inwardly by a fastener-abutment surface extending along a fastener-abutment plane defining an oblique angle with the trailing surface of the holder body.

According to another general aspect, there is provided a cutting disk of a rotary cutting machine. The cutting disk has a disk body with an outer periphery and a plurality of the saw tooth holder according to the present disclosure; the saw tooth holders are disposed on the outer periphery and being peripherally spaced-apart.

According to another general aspect, there is provided a saw tooth holder for a cutting disk of a rotary cutting machine, the saw tooth holder comprising a holder body having a tooth-receiving surface abuttable against a rear surface of a saw tooth of a tooth assembly and a trailing surface, opposed to the tooth-receiving surface, and defining a trailing oblique angle with respect to the tooth-receiving surface. The holder body has a fastener-receiving aperture extending therethrough between the tooth-receiving surface and the trailing surface and being accessible from the tooth-receiving surface and the trailing surface.

According to another general aspect, there is provided a cutting disk for a rotary cutting machine, the cutting disk comprising a disk body; and a plurality of saw tooth holders according to the present disclosure disposed along a periphery of the disk body and being peripherally spaced-apart from one another.

According to another general aspect, there is provided a saw tooth holder according to the present disclosure in combination with a tooth assembly comprising a saw tooth, having a rear surface juxtaposable against the tooth-receiving surface of the holder body, and a mechanical fastener insertable into the fastener-receiving aperture from the trailing surface and connectable to the saw tooth juxtaposed against the tooth-receiving surface to secure the saw tooth to the holder body.

According to another general aspect, there is provided a rotary cutting machine comprising a cutting disk according to the present disclosure.

According to another general aspect, there is provided a saw tooth holder for a cutting disk of a rotary cutting machine, the saw tooth holder comprising a holder body having a tooth-receiving surface abuttable against a rear face of a saw tooth of a tooth assembly, an opposed trailing surface, a fastener-receiving aperture extending through the holder body between the tooth-receiving surface and the trailing surface, and a fastener-receiving socket defined in the holder body, extending forwardly from the trailing surface, surrounding the fastener-receiving aperture along at least a portion thereof, and defining a fastener-abutment surface at least partially delimiting inwardly the fastener-receiving socket and configured to contact a head of a mechanical fastener of the tooth assembly, wherein the fastener-abutment surface extends along a fastener-abutment plane defining an oblique angle with the trailing surface.

According to another general aspect, there is provided a cutting disk for a rotary cutting machine, the cutting disk comprising a disk body; and a plurality of saw tooth holders according to the present disclosure disposed along a periphery of the disk body and being peripherally spaced-apart from one another.

According to another general aspect, there is provided cutting disk for a rotary cutting machine, the cutting disk comprising a disk body; and a plurality of saw tooth holders disposed along the disk body and being peripherally spaced-apart from one another. At least one of the plurality of saw tooth holders comprises a holder body having a tooth-receiving surface configured to contact a rear surface of a saw tooth of a tooth assembly, an opposed trailing surface comprising an inner end, adjacent to the disk body, and an outer end, and a fastener-receiving aperture extending through the holder body and along a fastener axis, between the tooth-receiving surface and the trailing surface and being accessible from the tooth-receiving surface and the trailing surface. The holder body further comprises a top portion extending between the outer end of the trailing surface and the tooth-receiving surface; and a body-linking portion extending between the inner end of the trailing surface and the tooth-receiving surface; wherein, considered along the fastener axis, a length of the body-linking portion is longer than a length of the top portion.

### BRIEF DESCRIPTION OF THE DRAWINGS

FIG. 1 is a perspective view of a cutting disk comprising a disk body and a plurality of circumferentially mounted saw tooth holders in accordance with an embodiment, together with an exploded view of a saw tooth assembly;

FIG. 2 is a cross-sectional view of the cutting disk of FIG. 1, in a plane extending perpendicularly to a rotation axis of the cutting disk;

FIG. 3 is an enlarged view of a portion of the cutting disk of FIG. 2, the saw tooth assemblies being removed;

FIGS. 4A and 4B are front and rear perspective views, respectively, of one of the saw tooth holders of FIG. 1, without the saw tooth assembly;

FIG. 5 is an enlarged view of one of the saw tooth holders of FIG. 2 with a saw tooth assembly being mounted to the saw tooth holder;

FIG. 6 is an enlarged view of the saw tooth holder of FIG. 5, without the saw tooth assembly;

FIG. 7 is an enlarged sectional view of a saw tooth holder in accordance with a second embodiment, with a saw tooth assembly being mounted to the saw tooth holder;

FIG. 8 is an enlarged view of the saw tooth holder of FIG. 7, without the saw tooth assembly;

FIG. 9 is an enlarged sectional view of a saw tooth holder in accordance with a third embodiment, with a saw tooth assembly being mounted to the saw tooth holder; and

FIG. 10 is an enlarged view of the saw tooth holder of FIG. 9, without the saw tooth assembly.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

Although various features may be described in the context of a single embodiment, the features may also be provided separately or in any suitable combination. Conversely, although the invention may be described herein in the context of separate embodiments for clarity, it may also be implemented in a single embodiment.

It is to be understood that the phraseology and terminology employed herein is not to be construed as limiting and is for descriptive purpose only.

The principles and uses of the teachings of the present disclosure may be better understood with reference to the accompanying description, figures and examples.

It is to be understood that the terms “including”, “comprising”, and grammatical variants thereof do not preclude the addition of one or more components, features, steps, or integers or groups thereof and that the terms are to be construed as specifying components, features, steps or integers.

If the specification or claims refers to “an additional” element”, that does not preclude there being more than one of the additional elements.

It is to be understood that, where the claims or specification refer to “a” or “an” element, such reference is not be construed that there is only one of that element.

It is to be understood that, where the specification states that a component, feature, structure, or characteristic “may”, “might”, “can” or “could” be included, that particular component, feature, structure, or characteristic is not required to be included.

The present disclosure relates generally to a cutting disk for a rotating cutting machine having a rotating disk, drum, cylinder or chain, etc., with peripherally mounted teeth. The teeth can be fixedly mounted to the periphery of the disk/drum/cylinder which in turn rotates or alternately the teeth can rotate about the periphery of a fixed disk/drum/cylinder. For instance, and without being limitative, the rotary cutting machines can include circular saws, chain saws, brush mowers, stump grinders, material shredders and the like. The rotary cutting machines may be used in various applications to cut workpiece material. The various applications can include, but are not limited to, felling trees and other natural plant growth in the forestry industry, cutting rock and/or earth in the mining and construction industries, shredding items such as used tires and other man-made products in various industrial applications, mowing brush and other material, and for cutting or grinding in agriculture. In one particular embodiment the cutting disk is a wood cutting disk, which can be adapted to felling trees.

### Cutting Saw Disk

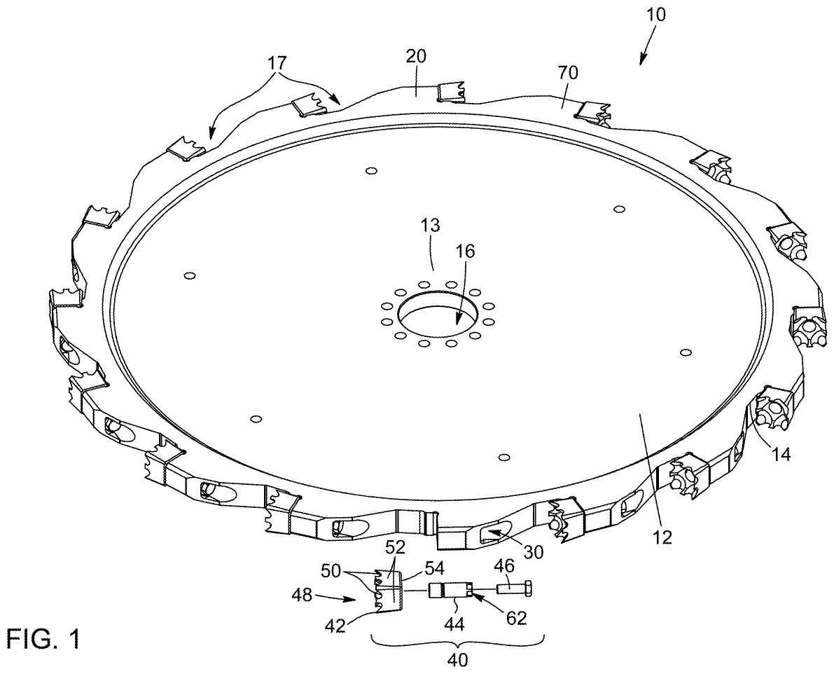

Referring now to the drawings, and more particularly to FIGS. 1 to 3, there is shown a cutting disk 10 (or cutting saw disk 10) having a substantially planar disk body 12 and being delimitated peripherally by an outer periphery 14. In the embodiment shown, the cutting disk 10 is a member designed to be rotatably mounted on a spindle in a machining unit or processing machine of the circular saw (not represented), the spindle being rotatably mounted about a rotation axis X1 in the processing machine of the circular saw. A spindle-receiving opening 16, which defines a rotation of the cutting disk 10, is formed centrally in a central portion 13 of the disk body 12 to rotatably mount the cutting disk 10 to the rotatable spindle. It is to be noted that the terms “outer” and “outwardly”, should be understood with opposition to the central portion 13 of the disk body 12 through which the spindle-receiving opening 16 is formed.

In the embodiment shown, the disk body 10 is substantially circular in shape but it is appreciated that other shapes could be foreseen. For instance, and without being limitative, the disc could have an oblong or an elliptical shape.

A plurality of peripherally (or circumferentially if the disk body 12 is substantially circular in shape as in the embodiment shown) interspaced saw tooth holders 20 are located peripherally of the disk body 12 and which, at least in the embodiment shown, protrude generally radially outward from a circular portion of the disk body 12 and therefore also from the central axis of rotation X1 of the cutting disk 12. Each one of the saw tooth holders 20 is designed to receive a saw tooth assembly 40, as will be described in more details below.

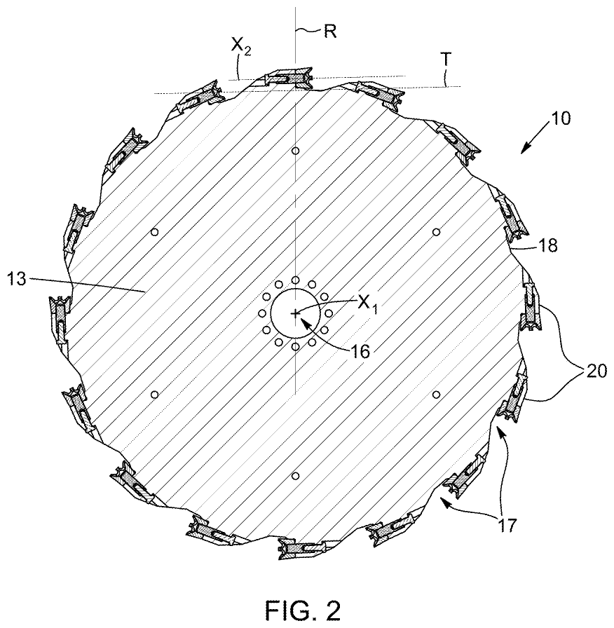

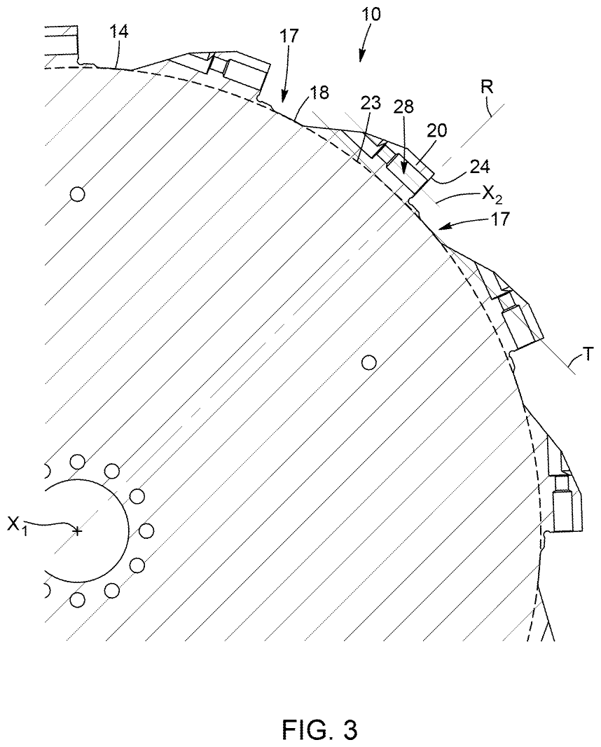

In the shown embodiment, the saw tooth holders 20 are integrally formed (i.e. monolithic) with the disk body 12. In other words, and as represented in FIGS. 2 and 3, gullet spaces 17 are formed in the cutting disk 10; the gullet spaces 17 extend between two successive saw tooth holders 20 so that the combination of the gullet spaces 17 and the saw tooth holders 20 forms a single piece having a substantially crown shape peripherally of the disk body 12. Alternately, the saw tooth holders 20 could be separately formed and secured permanently or removably to the disk body 12. As represented in FIG. 3, the disk body 12 has a central and circular portion 13 (represented in dotted lines in FIG. 3), considered in a plane substantially perpendicular to the rotation axis X1, delimited by segments defining a bottom wall portion 18 of the gullet spaces 17 and segments forming an interface (or linkage portion 23) with the saw tooth holders 20.

The linkage portion 23 can be imaginary if the tooth holders 20 are single piece with the central portion 13 of the disk body 12 or it can be defined by a perimeter of the disk body 12 onto which the tooth holders 20 are mounted, if the tooth holders 20 are separate components secured to the disk body 12. In the embodiment of a circular saw disk, the linkage portion 23 represents a section of the circumference of the central portion 13 of the disk body 12 with the tooth holders 20 protruding outwardly from this circumference.

In the embodiment shown, the saw tooth holders 20 are substantially equally spaced-apart from one another along the disk body 12. In the embodiment shown, eighteen saw tooth holders 20 protrude outwardly from the central portion 13 of the disk body 12. The disclosure is obviously not limited to the represented embodiment, and the cutting disk 10 could have a different number of saw tooth holders 20 arranged differently on—and mounted differently to—the disk body 12 of the cutting disk 10.

### Saw Tooth Holder—First Embodiment

In the shown embodiment, the saw tooth holders 20 have a similar shape; the following description of one them will thus apply to any of them.

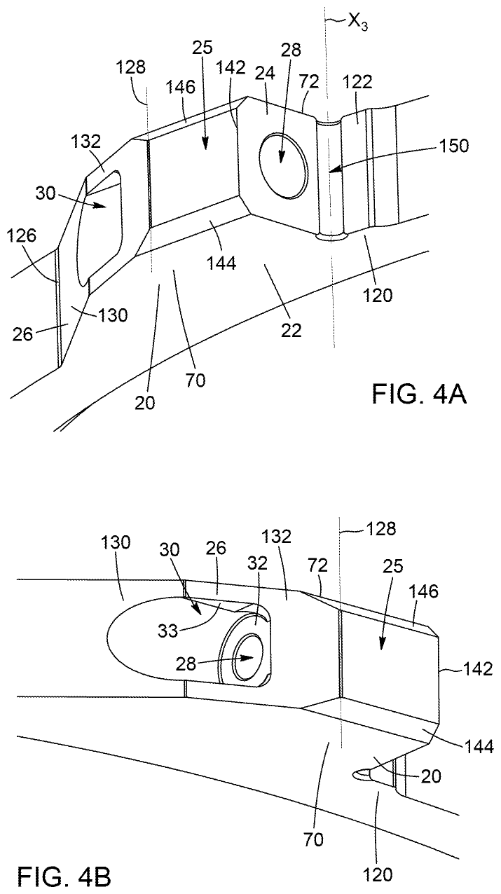

As shown in particular in FIGS. 4A, 4B, 5 and 6, the saw tooth holder 20 comprises a holder body 22 extending between a tooth-receiving surface 24 configured to receive a saw tooth 42 of the tooth assembly 40 (and more particularly a rear face or holder-contacting face 54 of the saw tooth 42), and an opposed trailing surface 26. The holder body 22 further extends between first and second lateral wall portions 70, 72 extending between the tooth-receiving surface 24 and the trailing surface 26. In the embodiment shown, the first and second lateral wall portions 70, 72 extend in substantially parallel planes, said planes being substantially perpendicular to the rotation axis X1 of the cutting disk 10. In the following description, unless otherwise stated, the terms front or forward should be understood with regards to the tooth-receiving surface 24, whereas the terms rear or rearward should be understood with regards to the trailing surface 26.

A fastener-receiving aperture 28 is formed in the holder body 22 and extends therethrough between the tooth-receiving surface 24 and the trailing surface 26, along a fastener axis X2. In the shown embodiment (see FIG. 3), the fastener axis X2 is substantially perpendicular to a radius R of the cutting disk 10 reaching the tooth-receiving surface 24 of the saw-tooth holder 20. In the embodiment shown, the radius R extends substantially in a plane defined by the tooth-receiving surface 24. In other words, in the embodiment shown, the fastener axis X2 is substantially parallel to a tangential direction T to the cutting disk 10 defined at a junction 15 of the tooth-receiving surface 24 and the central and circular portion 13 of the disk body 12.

A fastener-receiving socket (or counterbore) 30 is further defined in the holder body 22 of the saw tooth holder 20. The fastener-receiving socket 30 surrounds the fastener-receiving aperture 28 and is opened and accessible on the trailing surface 26 of the holder body 22. Therefore, adjacent to the trailing surface 26, the aperture defined in the holder body 22 includes the fastener-receiving aperture 28 and the fastener-receiving socket 30 surrounding the fastener-receiving aperture 28, without physical delimitation inbetween. The fastener-receiving socket 30 is delimited inwardly by a fastener-abutment surface 32 (i.e. considered along the fastener axis X2 in a direction towards the tooth-receiving surface 24) and peripherally by a peripheral wall 33. In the embodiment shown, and as represented for instance in FIG. 4A, the peripheral wall 33 extends only along an inner portion of the fastener-receiving socket 30.

In the embodiment shown, the fastener-receiving aperture 28 comprises successively, considered along the fastener axis X2 from the trailing surface 26 towards the tooth-receiving surface 24, a fastener-receiving portion 34, a central portion 36 having, in the shown embodiment, a substantially cylindrical shape with a first diameter d1, and a sleeve-receiving (or front) portion 38 having a substantially cylindrical shape with a second diameter d2, i.e. the portion extending rearwardly from the tooth-receiving surface 24. In the embodiment shown, the fastener-receiving aperture 28 further comprises an intermediate portion 29 extending between the sleeve portion 38 and the central portion 36. For instance, the intermediate portion 29 has a substantially frustoconical shape, i.e. its tapered portion extending between the sleeve portion 38 characterized by the second diameter d2 and the central portion 36 characterized by the first diameter d1. It is thus understood that the fastener-receiving socket 30 more particularly surrounds the fastener-receiving portion 34 of the fastener-receiving aperture 28.

In the shown embodiment, the sleeve-receiving (front) portion 38, the intermediate portion 29 and the central portion 36 are coaxial with the fastener axis X2, and the first diameter d1 is smaller than the second diameter d2. Thus, the intermediate portion 29 has a cross-section increasing, considered along the fastener axis X2, towards the tooth-receiving surface 24. In the shown embodiment, the sleeve-receiving portion 38, considered along the fastener axis X2, is longer than the central portion 36. In some embodiments, the sleeve-receiving portion 38, considered along the fastener axis X2, is between about two and about three times longer than the central portion 36. Moreover, in the embodiment shown, considered along the fastener axis X2, the fastener-receiving portion 34 is longer than the central portion 36. In the embodiment shown, considered along the fastener axis X2, a length of the fastener-receiving portion 34 is substantially similar to a length of the sleeve-receiving portion 38.

It is thus understood that the fastener-abutment surface 32 extends along a fastener-abutment plane defined between the fastener-receiving socket 30 and the central portion 36. Moreover, the fastener-abutment surface 32 extends between the tooth-receiving surface 24 and the trailing surface 26.

It is appreciated that the shape, the number, the configuration, the relative dimensions and the respective locations of the different portions of the fastener-receiving aperture 28 can vary from the embodiment shown.

In the shown embodiment, the tooth-receiving surface 24 and the fastener-abutment surface 32 extend substantially parallel to each other and both extend along a plane substantially perpendicular to the fastener axis X2 (or parallel to the radius R of the cutting disk 10 reaching the junction 15 of the tooth-receiving surface 24 of the holder body 22 and the central and circular portion 13 of the disk body 12).

The trailing surface 26 (or a plane thereof) defines a trailing oblique angle α, i.e. is not a right angle or a multiple of a right angle, with respect to at least one of the fastener-abutment surface 32 and the tooth-receiving surface 24 (with both the fastener-abutment surface 32 and the tooth-receiving surface 24, in the embodiment shown). In some embodiments, the trailing oblique angle α is comprised between about 10° and about 80°. In some other embodiments, the trailing oblique angle α is comprised between about 30° and about 60°. In yet some other embodiments, the trailing oblique angle α is comprised between about 40° and about 50°. It is thus understood that the trailing surface 26 is also inclined (i.e. is not a right angle or a multiple of a right angle) with respect to a plane perpendicular to the fastener axis X2 and also defines the trailing oblique angle α with a plane perpendicular to the fastener axis X2. It is further understood that the trailing surface 26 is inclined (i.e. is not a right angle or a multiple of a right angle) with respect to a plane perpendicular to the tangential direction T of the saw tooth holder 20 considered at the junction 15 of the tooth-receiving surface 24 and the central and circular portion 13 of the disk body 12 and defines the trailing oblique angle α with a plane perpendicular to the tangential direction T.

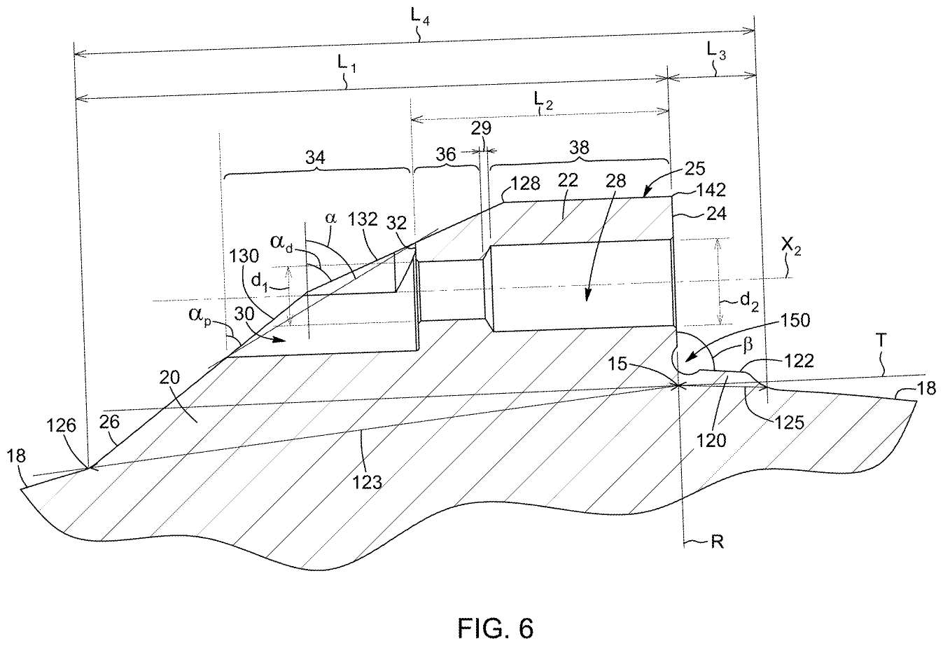

As represented in FIG. 6, the trailing surface 26 has an inner end 126 (corresponding to a junction of the trailing surface 26 and the linkage portion 23 of the disk body 12) and an opposed outer end 128, with the outer end 128 being closer to the fastener-abutment surface 32 than the inner end 126. A corresponding one of the bottom wall portions 18 of the gullet spaces 17 extends rearwardly from the inner end 126.

In the embodiment shown, the trailing surface 26 can be divided into an inner trailing surface 130 (or proximal trailing surface 130, considered with regards to the central portion 13 of the disk body 12) extending radially outward the inner end 126 and an outer trailing surface 132 (or distal trailing surface 132, considered with regards to the central portion 13 of the disk body 12). The outer trailing end 128 thus forms a junction between the outer trailing surface 132 and a top portion 25 (FIG. 6) of the holder body 22. The proximal and distal trailing surfaces 130, 132 are inclined with regards to each other, i.e. an oblique angle is defined inbetween.

In the embodiment shown, the proximal trailing surface 130 defines a proximal trailing oblique angle αp with respect to the tooth-receiving surface 24. In some embodiments, the proximal trailing oblique angle αp is comprised between about 10° and about 80°. In some other embodiments, the proximal trailing oblique angle αp is comprised between about 30° and about 60°. In yet some other embodiments, the proximal trailing oblique angle αp is comprised between about 40° and about 50°. It is thus understood that the proximal trailing surface 130 is also inclined (i.e. is not a right angle or a multiple of a right angle) with respect to a plane perpendicular to the fastener axis X2 and also defines the proximal trailing oblique angle αp with a plane perpendicular to the fastener axis X2. It is further understood that the proximal trailing surface 130 is inclined (i.e. is not a right angle or a multiple of a right angle) with respect to a plane perpendicular to the tangential direction T of the saw tooth holder 20 considered at the junction 15 of the tooth-receiving surface 24 and the central and circular portion of the disk body 12 and defines the proximal trailing oblique angle αp with a plane perpendicular to the tangential direction T.

In the embodiment shown, the distal trailing surface 132 defines a distal trailing oblique angle αd with respect to the tooth-receiving surface 24. In some embodiments, the distal trailing oblique angle αd is comprised between about 10° and about 80°. In some other embodiments, the distal trailing oblique angle αd is comprised between about 30° and about 60°. In yet some other embodiments, the distal trailing oblique angle αd is comprised between about 40° and about 50°. It is thus understood that the distal trailing surface 132 is also inclined (i.e. is not a right angle or a multiple of a right angle) with respect to a plane perpendicular to the fastener axis X2 and also defines the distal trailing oblique angle αd with a plane perpendicular to the fastener axis X2. It is further understood that the distal trailing surface 132 is inclined (i.e. is not a right angle or a multiple of a right angle) with respect to a plane perpendicular to the tangential direction T of the saw tooth holder 20 considered at the junction 15 of the tooth-receiving surface 24 and the central and circular portion of the disk body 12 and defines the distal trailing oblique angle αd with a plane perpendicular to the tangential direction T.

The trailing oblique angle α is thus defined between the plane connecting the inner end 126 and the outer end 128 of the trailing surface 26 and the tooth-receiving surface 24. A value of the trailing oblique angle α is thus comprised between a value of the proximal trailing oblique angle αp and a value of the distal trailing oblique angle αd.

In the embodiment shown, the proximal trailing oblique angle αp is smaller than the distal trailing oblique angle αd so that the trailing surface 26 defines a bump or convexity. It could also be conceived a saw tooth holder 20 in which the proximal trailing oblique angle αp would be greater than the distal trailing oblique angle αd so that the trailing surface 26 would form a recess or concavity.

The present disclosure is not limited to a trailing surface 26 having two substantially planar portions. It could also be conceived a saw tooth holder 20 having more than two planar portions, or having a single planar portion, as represented in the second embodiment of the saw tooth holder 220 described below. It could also be conceived a saw tooth holder 20 having a trailing surface 26 with a substantially curved shape, so that a convexity or a concavity would be formed on the trailing surface 26.

The trailing surface 26 is thus shaped and designed so that the linkage portion 23 via which the holder body 22 of the saw tooth holder 20 is linked to the central portion of the disk body 12 (i.e. the linkage portion 23 as represented in FIGS. 3 and 6 extending below the holder body 22) has a length L1 greater than a length L2 of the opposed top portion 25 of the holder body 22. In the embodiment shown, the top portion 25 extends between the outer end 128 of the trailing surface 26 and an upper edge of the tooth-receiving surface 24. In other words, the holder body 22 has a substantially trapezoidal profile with a short top portion 25 and longer inner portion, adjacent to the linking portion 23.

In the embodiment shown, the top portion 25 extends—considered along a direction substantially parallel to the rotation axis X1—between the first and second lateral wall portions 70, 72 and between the outer end 128 of the trailing surface 26 and a front edge 142, which is a straight edge in the non-limitative embodiment shown, defined at a junction of the tooth-receiving surface and an upper surface of the top portion 25.

In the embodiment shown, the top portion 25 has substantially trapezoidal beveled edges 144, 146 connecting an upper surface of the top portion 25 to the first and second lateral wall portions 70, 72.

It is appreciated that the shape, the configuration, and the respective arrangement of the top portion 25 can vary from the embodiment shown. It could, for instance, be conceived a top portion 25 without beveled edges.

In the embodiment shown, the saw tooth holder 20 further comprises a tooth-receiving base 120 protruding outwardly from the linkage portion 23 of the disk body 12 and comprising a tooth-side receiving surface 122. The tooth-receiving base 120 extends outwardly past the bottom wall portion 18 of the gullet space 17 extending forwardly of the tooth-receiving surface 24. For instance, the tooth-side receiving surface 122 forms with the tooth-receiving surface 24 an inclination angle β greater than about 90°. In some embodiments the angle β is greater than about 100°. In the embodiment shown, a gutter 150 is formed in the saw tooth holder 20, and more particularly at a junction of the tooth-receiving surface 24 and the tooth-side receiving surface 122 of the tooth-receiving base 120.

The gutter 150 extends along a gutter axis X3, substantially perpendicular to the fastener axis X2. In the embodiment shown, the gutter axis X3 is substantially parallel to the rotation axis X1 of the disk body 12.

It is thus understood that the tooth-receiving base 120 extends forwardly of the tooth-receiving surface 24. Each one of the linkage portions 23 via which the saw tooth holders 20 are linked to the outer periphery 14 of the disk body 12 can be divided into body-linking portions 123 and base-linking portions 125. The body-linking portion 123 corresponds to the portion extending below the holder body 22 while the base-linking portion 125 corresponds to the portion extending below the tooth-receiving base 120, as shown in FIG. 6. In the embodiment shown, a length L3 of the base-linking portion 125 is shorter than the length L2 of the top portion 25.

In some embodiments, the length L1 of the body-linking portion 123 is greater than about 120% of the length L2 of the top portion 25. In some other embodiments, the length L1 is greater than about 150% of the top portion 25. In yet some other embodiments, the length L1 is at least about 2 times greater than the length L2 of the top portion.

### Tooth Assembly

In the shown embodiment, all the tooth assemblies 40 have a similar shape. The following description of one of the tooth assemblies 40 will thus apply to any of them.

As mentioned above, the tooth assembly 40 comprises a saw tooth 42. As represented in particular in FIGS. 1 and 3, the tooth assembly 40 further comprises a fastener extension sleeve 44 and a mechanical fastener 46, such as a screw or a bolt. In the embodiment shown in the Figures, the mechanical fastener 46 is embodied by a screw. The screw 46 and the fastener extension sleeve 44 are engageable together and configured to secure the saw tooth 42, superposed to the tooth-receiving surface 24, to the saw tooth holder 20.

In the embodiment shown, the saw tooth 42 has a substantially square frustopyramidal shape with a recess 48, for instance substantially concave, on a leading face 49 thereof, defining cutting edges 50. The saw tooth 42 also comprises divergent side surfaces 52, the cutting edges 50 being defined at the intersection of the recess 48 and the divergent side surfaces 52.

The saw tooth 42 further comprises a holder-contacting face 54 opposed to the leading face 49 and juxtaposable to the tooth-receiving surface 24 of the saw tooth holder 20. The saw tooth 42 also includes a mounting socket 56 being formed in the holder-contacting face 54. The mounting socket 56 is designed to receive a leading end 58 of the fastener extension sleeve 44. In the shown embodiment, an outer thread is formed on an outer surface of the leading end 58 of the fastener extension sleeve 44, at least along a leading section thereof, the outer thread being dimensioned to cooperate with an inner thread formed on an inner surface of a peripheral wall defining the mounting socket 56 of the saw tooth 42, so that the leading end 58 of the fastener extension sleeve 44 can be fastened to the saw tooth 42. It is appreciated that any other removable mechanical connection between the saw tooth 42 and the fastener extension sleeve 44 could be conceived.

In the shown embodiment, the fastener extension sleeve 44 has a substantially cylindrical shape defining a diameter corresponding substantially to the second diameter d2 of the sleeve-receiving portion 38 of the fastener-receiving aperture 28. The fastener extension sleeve 44 further comprises a trailing end 60, opposed to the leading end 58. In the shown embodiment, an inwardly threaded elongated channel 62 is defined in the fastener extension sleeve 44 and extends inwardly from the trailing end 60.

In the shown embodiment, the screw 46 comprises a substantially cylindrical shaft 63 extending from a head 66. The cylindrical shaft 63 has a diameter corresponding substantially to the first diameter d1 of the central portion 36 of the fastener-receiving aperture 28. The shaft 63 of the screw 46 further comprises a threaded leading end 64. The thread formed on an outer surface of the screw 46 (i.e. the threaded leading end 64) is configured to cooperate with a thread formed on an inner surface of a peripheral wall defining the elongated channel 62 of the fastener extension sleeve 44. It is appreciated that any other removable mechanical connection between the shaft 63 of the screw 46 and the fastener extension sleeve 44 could be conceived. The fastener shaft 63 comprises an opposed trailing end 65. The screw 46 can thus be fastened to the fastener extension sleeve 44 by insertion into the mounting aperture (elongated channel) 62 and engagement of the complementary threads. The head 66 of the screw 46 is mounted to and protrudes from the trailing end 65 of the shaft 63, the head 66 having a section greater than the cross-section of the shaft 63 (i.e. greater than the first diameter d1 of the central portion 36 of the fastener-receiving aperture 28), so that an abutting surface 68 is defined between the head 66 and the shaft 63 of the screw 46.

It is to be noted that the structure of the tooth assembly 40 is obviously not limited to the one described above. In particular, alternate embodiments could be conceived for the fastener extension sleeve 44 and the screw 46. For instance, it could be conceived a tooth assembly in which the saw tooth 42 and the fastener extension sleeve 44 could be monolithic. Alternatively, a tooth assembly 40 could be conceived in which the cylindrical shaft 63 of the screw 46 would form the fastener extension sleeve 44 and, therefore, the screw 46 can be engaged directly with the saw tooth 42, i.e. without a separate extension sleeve 44 extending inbetween.

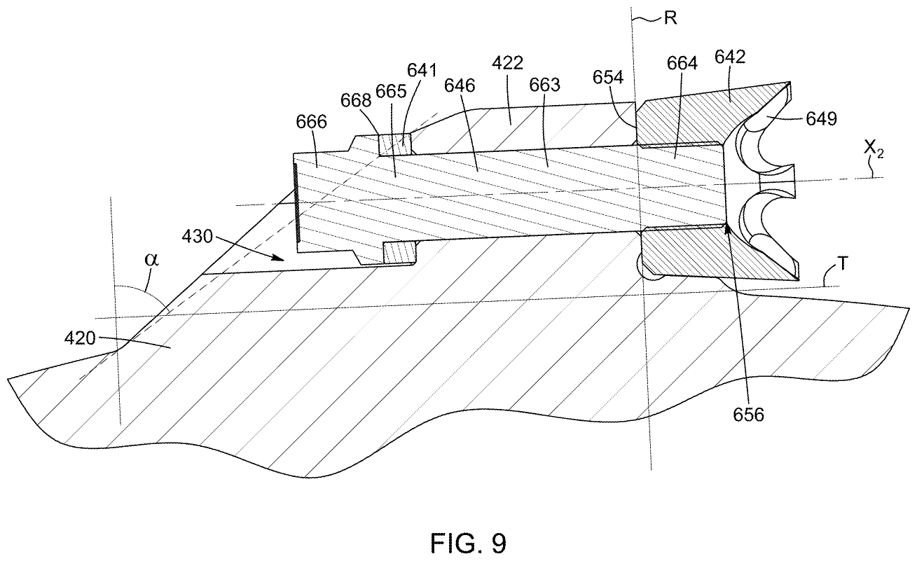

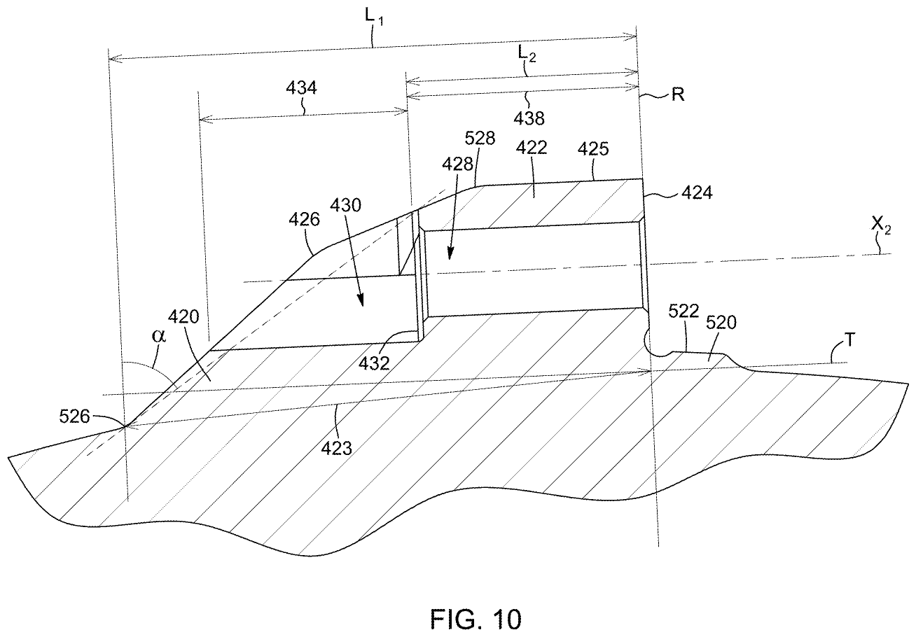

An embodiment of a saw tooth holder 420 configured to cooperate with a tooth assembly 640 comprising a saw tooth 642 and a mechanical fastener 646 (or screw 646) engageable directly with the saw tooth 642 is represented in FIGS. 9 and 10. Similarly to the other embodiments of the saw tooth holder, the saw tooth holder 420 in accordance with the third embodiment comprises a tooth-receiving surface 424, an opposed trailing surface 426 and a holder body 422 extending between the tooth-receiving surface 424 and the trailing surface 426. A fastener-receiving aperture 428 extends through the holder body 422 and between the tooth-receiving surface 424 and the trailing surface 426. The trailing surface 426 defines a trailing oblique angle α with respect to the tooth-receiving surface 424 and comprises an inner end 526 and an outer end 528.

Moreover, similarly to the first and second embodiments, the trailing surface 426 of the third embodiment of the saw tooth holder 420 is shaped and dimensioned so that the top portion 425 has a length L2 considered along the fastener axis X2 that is smaller than a length L1 of the body-linking portion 423.

A fastener-receiving socket 430 is also defined in the holder body 422 of the third embodiment of the saw tooth holder 420. The fastener-receiving socket 430 is delimited inwardly by a fastener-abutment surface 432 (i.e. considered along the fastener axis X2 in a direction towards the tooth-receiving surface 424) and peripherally by a peripheral wall.

The saw tooth holder 420 also comprises a tooth-receiving base 520 protruding outwardly from the outer periphery 14 of the disk body 12. It is understood that the height of the tooth-receiving base 520 (i.e. the radial position of the tooth-side receiving surface 522) as well as the profile of the tooth-side receiving surface 522 can vary from the embodiment shown, for the tooth-receiving base 522 to be adapted to the saw tooth of the saw tooth assembly 640 configured to be mounted to the saw tooth holder 420.

The third embodiment of the saw tooth holder 420 distinguishes from the first and second embodiments in particular by the fact that the fastener-receiving aperture 428 comprises successively, considered along the fastener axis X2 from the trailing surface 426 towards the tooth-receiving surface 424, a fastener-receiving portion 434 and a front portion 438 (or shaft-receiving portion 438) having a substantially cylindrical shape (i.e. the fastener-receiving aperture 428 does not comprise a plurality of portions between the fastener-receiving portion 434 and the tooth-receiving surface 424 that would have different diameters and/or shapes). The front portion 438 is coaxial with the fastener axis X2. It is thus understood that the fastener-abutment surface 432 extends along a fastener-abutment plane defined between the fastener-receiving socket 430 and the shaft-receiving portion 438 (or front-portion 438) of the fastener-receiving aperture 428. Moreover, the fastener-abutment surface 432 extends between the tooth-receiving surface 424 and the trailing surface 426.

As represented in FIG. 9, the saw tooth holder 420 in accordance with the third embodiment is configured to cooperate with the saw tooth 642 and the mechanical fastener 646 of the tooth assembly 440.

The saw tooth 642 comprises a holder-contacting face 654 opposed to a leading face 649 and juxtaposable to the tooth-receiving surface 424 of the saw tooth holder 420. The saw tooth 642 also includes a mounting socket 656 being formed in the holder-contacting face 654.

The mechanical fastener 646 (or screw 646) comprises a shaft 663 extending from a head 666. The cylindrical shaft 663 has a diameter corresponding substantially to the diameter of the front portion 438 of the fastener-receiving aperture 428. The shaft 663 of the screw 646 further comprises a threaded leading end 664.

The mounting socket 656 of the saw tooth 642 is designed to receive directly the leading end 664 of the mechanical fastener 646. In the shown embodiment, an outer thread is formed on an outer surface of the leading end 664 of the mechanical fastener 646, at least along a leading section thereof, the outer thread being dimensioned to cooperate with an inner thread formed on an inner surface of a peripheral wall defining the mounting socket 656 of the saw tooth 642, so that the leading end 664 of the mechanical fastener 646 can be directly fastened to the saw tooth 642. It is appreciated that any other removable mechanical connection between the saw tooth 642 and the mechanical fastener 646 could be conceived.

The head 666 of the screw 646 (or mechanical fastener 646) is mounted to and protrudes from a trailing end 665 of the shaft 663, the head 666 having a section greater than the cross-section of the shaft 663 (i.e. greater than the diameter of the front portion 438 of the fastener-receiving aperture 428), so that an abutting surface 668 is defined between the head 666 and the shaft 663 of the screw 646. The tooth assembly 640 might optionally further comprise a washer 641 sandwiched between the abutting surface 668 of the screw 646 and the fastener-abutment surface 432 delimiting the fastener-receiving socket 430, when the tooth assembly 640 is mounted to the saw tooth holder 420. Thus contrary to the other embodiments of the saw tooth holder 20, 220, the saw tooth holder 420 in accordance with the third embodiment is shaped and dimensioned to allow the mounting of a tooth assembly 640 having a mechanical fastener 646 engageable directly with a saw tooth 642. It is understood that the direct engagement of the saw tooth 642 and the mechanical fastener 646 refers to the fact that the tooth assembly 640 does not comprise an additional component, such as a fastener extension sleeve receivable in the fastener-receiving aperture 428, but does not preclude the use of a washer or any other intermediate component increasing the cooperation between the mechanical fastener 646 and the fastener-abutment surface 432 delimiting the fastener-receiving socket 430.

It is appreciated that the shape of the saw tooth holder 420, in particular the shape, the configuration and the relative position of the tooth-receiving surface 424 and the trailing surface 426 can vary from the third embodiment shown. Moreover, it should be understood that, in the embodiments in which the saw tooth holder is not made integral with the disk body, the shapes, dimensions and positions of the linkage portion, the body-linking portion and/or the base-linking portion could vary from the embodiments shown.

The tooth assembly 40, 640 could further comprise additional elements, so as to yet better cooperate with the saw tooth holder 20, 220, 420. Moreover, the cooperation between the different components of the tooth assembly 40, 640 is obviously not limited to the above-described threads; the components could be secured together by any other means, such as adhesive, rivets, welding, and the like.

### Mounting of the Tooth Assembly to the Saw Tooth Holder

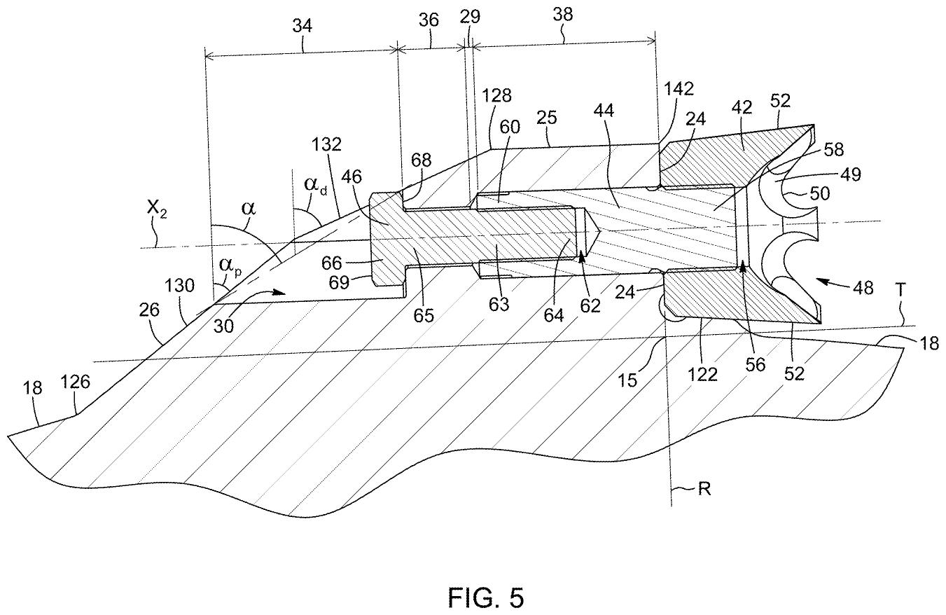

As represented in particular in FIG. 5, the tooth assembly 40 is configured to be mounted to the saw tooth holder 20 (to be removably mounted thereto, in the embodiment shown).

In the embodiment shown, the mounting of the tooth assembly 40 to the saw tooth holder 20 firstly comprises securing the fastener extension sleeve 44 to the saw tooth 42, the leading end 58 of the fastener extension sleeve 44 being inserted into the mounting socket 56 defined in the holder-contacting face 54 of the saw tooth 42. When secured together, the fastener extension sleeve 44 and the saw tooth 42 form a sleeve and tooth assembly.

The mounting of the tooth assembly 40 to the saw tooth holder 20 further comprises inserting the fastener extension sleeve 44 of the sleeve and tooth assembly into the fastener-receiving aperture 28 from the port defined in the tooth-receiving surface 24 of the saw tooth holder 20 until the holder-contacting face 54 of the saw tooth 42 contacts the tooth-receiving surface 24 of the saw tooth holder 20.

The mounting of the tooth assembly 40 then comprises introducing the leading end 64 of the screw 46 into the fastener-receiving socket 30 and into the fastener-receiving aperture 28 from the port defined in the trailing surface 26. In other words, the leading end 64 of the screw 46 is introduced into the central portion 36 of the fastener-receiving aperture 28. The leading end 64 of the screw 46 is then engaged into the elongated channel 62 of the fastener extension sleeve 44 to secure together the fastener extension sleeve 44 and the screw 46.

As represented in FIG. 5, when the tooth assembly 40 is mounted to the saw tooth holder 20, the fastener extension sleeve 44 is sandwiched between the saw tooth 42 and the screw 46 in a manner such that the abutting surface 68 of the screw 46 abuts against the fastener-abutment surface 32 of the saw tooth holder 20, and the holder-contacting face 54 of the saw tooth 42 abuts against the tooth-receiving surface 24 of the saw tooth holder 20. When the tooth assembly 40 is mounted to the saw tooth holder 20, both the screw 46 and the fastener extension sleeve 44 extend along the fastener axis X2.

In the shown embodiment, the head 66 of the screw 46 is at least partially received in the fastener-receiving socket 30 defined in the trailing surface 26 of the saw tooth holder 20 when the tooth assembly 40 is mounted to the saw tooth holder 20. In other words, when the tooth assembly 40 is mounted to the saw tooth holder 20, at least a portion of the head 66 of the screw 46 does not protrude outwardly from the trailing surface 26. This arrangement of the tooth assembly 40 is made possible by the above-disclosed inclination of the trailing surface 26 with respect to the tooth-receiving surface 24. In the first embodiment of the saw tooth holder 20, as represented in FIG. 5, the head 66 is substantially contained in the fastener-receiving socket 30. In other words, the head 66 (at least the abutting surface 68 thereof) is recessed from the trailing surface 26 of the saw tooth holder 20.

It could be conceived a saw tooth holder 20 dimensioned so that the head 66 would be entirely contained in the fastener-receiving socket 30 when the tooth assembly 40 is mounted to the saw tooth holder 20 (i.e. so that a trailing face 69 of the head 66 would be recessed from the trailing surface 26 of the saw tooth holder 20 when the tooth assembly 40 is mounted to the saw tooth holder 20). To this end, the dimensions of the fastener-abutment surface 32 and/or the inclination of the trailing surface 26 with regards to the tooth-receiving surface 24 can be adjusted.

Moreover, as represented in FIG. 5, when the saw tooth assembly 40 is mounted to the saw tooth holder 20, one of the side surfaces 52 contacts, at least along a portion thereof, the tooth-side receiving surface 122 of the tooth-receiving base 120.

It is known that, when the rotary cutting machine is actuated for the cutting disk 10 or at least a portion thereof including the saw tooth holders 20 to be rotated around the rotation axis X1, so that the saw teeth 42 sequentially contact the workpiece material to be sawed, high levels of stress are communicated to the saw tooth holders 20. By having a saw tooth holder 20 having an inclined trailing surface 26 with mechanical fasteners having a head at least partially contained inside the saw tooth holder 20 (i.e. at least partially contained in the fastener-receiving socket 30 thereof), the saw tooth holders 20 have a greater volume and therefore can better sustain higher stresses—or forces—applied thereon in comparison with saw tooth holders having a trailing surface extending substantially parallel to the tooth-receiving surface.

As represented in particular in FIGS. 5 and 6, and as mentioned above, the holder body 22 of the saw tooth holder 20 is connected to the central portion 13 of the disk body 12 along the linkage portion 23 comprising the body-linking portion 123. It is to be further noted that the inclination of the trailing surface 26 is arranged so that the length L4—considered along a direction substantially parallel to fastener axis X2—of the linkage portion 23 (comprising, in the embodiment shown, the length L1 of the body-linking portion 123 and the length L3 of the base-linking portion 125) is increased with comparison to a saw tooth holder in which the trailing surface would be substantially parallel to the tooth-receiving surface. It is thus understood that the inclination of the trailing surface 26 of the saw tooth holders 20 with respect to the corresponding tooth-receiving surface 24 contributes to the durability of the cutting disk 10 according to the present disclosure.

### Saw Tooth Holder—Second Embodiment

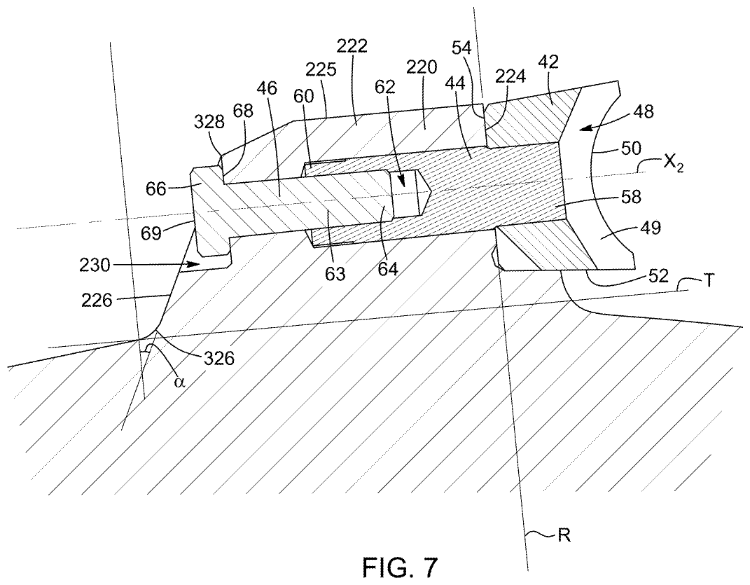

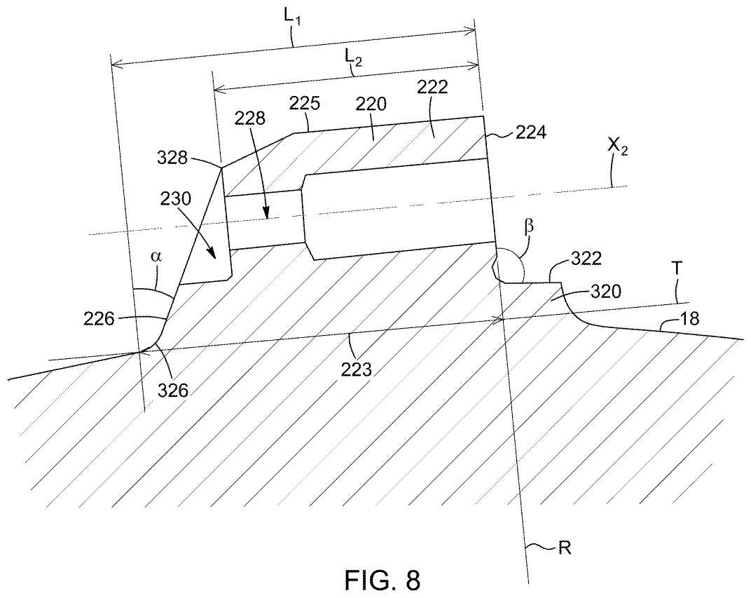

The second embodiment of the saw tooth holder 220 is represented in FIGS. 7 and 8. Similarly to the first embodiment, the saw tooth holder 220 in accordance with the second embodiment comprises a tooth-receiving surface 224, an opposed trailing surface 226 and a holder body 222 extending between the tooth-receiving surface 224 and the trailing surface 226. A fastener-receiving aperture 228 extends through the holder body 222 and between the tooth-receiving surface 224 and the trailing surface 226. The trailing surface 226 defines a trailing oblique angle α with respect to the tooth-receiving surface 224 and comprises an inner end 326 and an outer end 328.

Moreover, similarly to the first embodiment, the trailing surface 226 of the second embodiment of the saw tooth holder 220 is shaped and dimensioned so that the top portion 225 has a length L2 considered along the fastener axis X2 that is smaller than a length L1 of the body-linking portion 223.

The second embodiment of the saw tooth holder 220 distinguishes from the first embodiment in particular by the profile of the trailing surface 226. In the embodiment shown, the trailing surface 226 comprises a single planar portion. Moreover, the trailing oblique angle α of the second embodiment of the saw tooth holder 220 is smaller than the trailing oblique angle α of the saw tooth holder 20.

The saw tooth holder 220 also comprises a tooth-receiving base 320 protruding outwardly from the outer periphery 14 of the disk body 12. It is understood that the height of the tooth-receiving base 320 (i.e. the radial position of the tooth-side receiving surface 322) as well as the profile of the tooth-side receiving surface 322 can vary from the embodiments shown, for the tooth-receiving base 320 to be adapted to the saw tooth of the saw tooth assembly 40 configured to be mounted to the saw tooth holder.

As represented in FIG. 7, the fastener-receiving socket 230 formed in the holder body 222 of the saw tooth holder 220 is shaped and dimensioned to contain at least partially the head 66 of the mechanical fastener 46 when the saw tooth assembly 40 is mounted to the saw tooth holder 220.

It is appreciated that the shape of the saw tooth holder 20, 220, in particular the shape, the configuration and the relative position of the tooth-receiving surface 24, 224 and the trailing surface 26, 226 can vary from the first and second embodiments shown. Moreover, it should be understood that, in the embodiments in which the saw tooth holder is not made integral with the disk body, the shapes, dimensions and positions of the linkage portion, the body-linking portion and/or the base-linking portion could vary from the embodiments shown.

It will be appreciated that the methods described herein with regards to the mounting of the saw tooth assembly 40 to the saw tooth holder 20, 220 may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A saw tooth holder for a cutting disk of a rotary cutting machine, the saw tooth holder comprising:
a holder body having a tooth-receiving surface abuttable against a rear surface of a saw tooth of a tooth assembly and a trailing surface, opposed to the tooth-receiving surface, and defining a trailing oblique angle with respect to the tooth-receiving surface,
the holder body having a fastener-receiving aperture extending therethrough between the tooth-receiving surface and the trailing surface and being accessible from the tooth-receiving surface and the trailing surface,
wherein the trailing oblique angle is comprised between about 30 degrees and about 60 degrees, and
wherein the fastener-receiving aperture extends along a fastener axis substantially perpendicular to the tooth-receiving surface and includes a front portion extending rearwardly from the tooth-receiving surface, the saw tooth holder further comprising a fastener-receiving socket defined therein and extending forwardly from the trailing surface and surrounding the fastener-receiving aperture and defining a fastener-abutment surface in the holder body, the fastener-abutment surface at least partially delimiting inwardly the fastener-receiving socket and extending substantially parallel to the tooth-receiving surface.

2.-3. (canceled)

4. The saw tooth holder according to claim 1, wherein the fastener-receiving aperture further comprises a central portion extending between the front portion and the fastener-receiving socket, wherein the central portion has a smaller diameter than a diameter of the fastener-receiving socket and a diameter of the front portion.

5. The saw tooth holder according to claim 1, wherein the trailing surface comprises an inner end and an outer end with the holder body further comprising a top portion extending between the outer end of the trailing surface and the tooth-receiving surface, and a body-linking portion extending between the inner end of the trailing surface and the tooth-receiving surface, wherein, considered along the fastener axis, a length of the body-linking portion is longer than a length of the top portion.

6. A cutting disk for a rotary cutting machine, the cutting disk comprising:
a disk body; and
a plurality of saw tooth holders as claimed in claim 1 disposed along a periphery of the disk body and being peripherally spaced-apart from one another.

7. The cutting disk according to claim 6, wherein at least one of the saw tooth holders and the disk body further comprises a tooth-receiving base configured to contact a side surface of the saw tooth, the tooth-receiving base extending forwardly of the tooth-receiving surface.

8. The cutting disk according to claim 7, wherein the tooth-receiving base comprises a tooth-side receiving surface defining an inclination angle greater than 90 degrees with the tooth-receiving surface and wherein at least one of the saw tooth holders and the disk body comprises a gutter formed at a junction of the tooth-receiving surface and the tooth-side receiving surface.

9. (canceled)

10. The cutting disk according to claim 6, wherein the saw tooth holders are made integral with the disk body.

11. The saw tooth holder as claimed in claim 1 in combination with a tooth assembly comprising a saw tooth, having a rear surface juxtaposable against the tooth-receiving surface of the holder body, and a mechanical fastener insertable into the fastener-receiving aperture from the trailing surface and connectable to the saw tooth juxtaposed against the tooth-receiving surface to secure the saw tooth to the holder body.

12. The combination according to claim 11, wherein the mechanical fastener comprises a fastener shaft insertable in the fastener-receiving aperture and a head with the head abutting against the fastener-abutment surface and at least partially contained in the fastener-receiving socket, when the mechanical fastener is inserted in the fastener-receiving aperture to secure the saw tooth to the holder body and wherein the tooth assembly comprises a fastener extension sleeve insertable into the fastener-receiving aperture and securable to the mechanical fastener and the saw tooth to connect the mechanical fastener and the saw tooth together.

13. (canceled)

14. A rotary cutting machine comprising the cutting disk according to claim 6.

15.-27. (canceled)

28. A cutting disk for a rotary cutting machine, the cutting disk comprising:
a disk body; and
a plurality of saw tooth holders disposed along the disk body and being peripherally spaced-apart from one another, at least one of said plurality of saw tooth holders comprising:
a holder body having a tooth-receiving surface configured to contact a rear surface of a saw tooth of a tooth assembly, an opposed trailing surface comprising an inner end, adjacent to the disk body, and an outer end, and a fastener-receiving aperture extending through the holder body and along a fastener axis, between the tooth-receiving surface and the trailing surface and being accessible from the tooth-receiving surface and the trailing surface, wherein the holder body further comprises:
a top portion extending between the outer end of the trailing surface and the tooth-receiving surface; and
a body-linking portion extending between the inner end of the trailing surface and the tooth-receiving surface;
wherein, considered along the fastener axis, a length of the body-linking portion is longer than a length of the top portion,
wherein the length of the body-linking portion is at least about two times longer than the length of the top portion.

29. The cutting disk according to claim 28, wherein said at least one of said plurality of saw tooth holders is made integral with the disk body.

30. The cutting disk according to claim 28, wherein said at least one of said plurality of saw tooth holders is removably mounted to the outer periphery of the disk body.

31. The cutting disk according to claim 28, further comprising a tooth assembly mounted to said at least one of said plurality of saw tooth holders, the tooth assembly comprising a saw tooth, having a rear surface juxtaposable against the tooth-receiving surface of the holder body, and a mechanical fastener, wherein the mechanical fastener is insertable into the fastener-receiving aperture from the trailing surface and connectable to the saw tooth juxtaposed against the tooth-receiving surface to secure the saw tooth to the holder body and wherein the tooth assembly comprises a fastener extension sleeve insertable into the fastener-receiving aperture and securable to the mechanical fastener and the saw tooth to connect the mechanical fastener and the saw tooth together.

32. (canceled)

33. The cutting disk according to claim 31, wherein the holder body further comprises a fastener-receiving socket, defined in the holder body and extending from the trailing surface and surrounding the fastener-receiving aperture, and a fastener-abutment surface at least partially delimiting the fastener-receiving socket, and wherein the mechanical fastener comprises a fastener shaft insertable in the fastener-receiving aperture and a head with the head abutting against the fastener-abutment surface when the mechanical fastener is inserted in the fastener-receiving aperture.

34. The cutting disk according to claim 33, wherein the head is at least partially contained in the fastener-receiving socket, when the mechanical fastener is inserted in the fastener-receiving aperture to secure the saw tooth to the holder body.

35. The cutting disk according to claim 34, wherein the fastener-receiving socket is at least partially delimited peripherally by a peripheral wall, wherein the fastener-receiving aperture forms a fastener-engaging opening in the fastener-abutment surface, the peripheral wall comprising first and second peripheral wall portions bordering the fastener-engaging opening on first and second sides thereof and extending rearwardly from the fastener-abutment surface.

36. The cutting disk according to claim 28, wherein the fastener axis extends substantially perpendicular to the tooth-receiving surface and the trailing surface defines an oblique angle with respect to the fastener axis.

37. A rotary cutting machine comprising the cutting disk according to claim 28.

38. The saw tooth holder according to claim 1, wherein the holder body comprises first and second lateral wall portions extending between the tooth-receiving surface and the trailing surface, wherein the first and second lateral wall portions extend at least partially rearwardly from the fastener-abutment surface and at least partially delimit together the fastener-receiving socket.

39. The saw tooth holder according to claim 1, wherein the fastener-receiving socket is at least partially delimited peripherally by a peripheral wall, wherein the fastener-receiving aperture forms a fastener-engaging opening in the fastener-abutment surface, the peripheral wall comprising first and second peripheral wall portions bordering the fastener-engaging opening on first and second sides thereof and extending rearwardly from the fastener-abutment surface.
